(19) United States
(12) Patent Application Publication
(10) Pub. No.: US 2008/0028940 A1
(43) Pub. Date: Feb. 7, 2008

(54) Air purifier and control method thereof

(75) Inventors: Jae Oh Han, Yongin-si (KR); Jai Kwon Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/643,796

(22) Filed: Dec. 22, 2006

(30) Foreign Application Priority Data
Aug. 7, 2006 (KR) 2006-74327

(51) Int. Cl. B01D 45/12

(52) U.S. Cl. 96/417; 55/345

(57) ABSTRACT

An air purifier and a control method thereof. The air purifier includes a main body having an air inlet and an air outlet, a fan mounted in the main body, rotational speed of which is changed according to a user-desired air flow rate, cyclones disposed in parallel with each other under the fan, at least one open/close unit to open and close at least one of the cyclones. The open/close unit may include a valve member to open and close an outflow pipe of the cyclone, and a stepping motor to rotate the valve member. An anemometer is mounted to at least one of the cyclones. Accordingly, since the air purifier can measure a speed of air flow in the cyclone and correspondingly change the operating number of the dust-collecting cyclones in an open state, the air purifier can achieve a predetermined dust-collecting performance even when the speed of the air flow in the cyclone is reduced.

### CROSS-REFERENCE TO RELATED APPLICATIONS

This application claims priority under 35 U.S.C. § 119(a) of Korean Patent Application No. 2006-0074327, filed on Aug. 7, 2006 in the Korean Intellectual Property Office, the disclosure of which is incorporated herein in its entirety by reference.

### BACKGROUND OF THE INVENTION

1. Field of the Invention

The present general inventive concept relates to an air purifier, and more particularly to an air purifier having cyclones which separate dust from polluted air by using a centrifugal force.

2. Description of the Related Art

An air purifier is an apparatus for removing dust, bacteria, and other contaminants from air, and for supplying purified air. Generally, the air purifier includes a fan for forcibly circulating indoor air and a dust collector for collecting dust from air.

Recently, the air purifier using a cyclone as the dust collector (hereinafter, which will be called a “cyclone air purifier”) has been developed. The cyclone is a device for separating solid particles from fluid by using a centrifugal force which is generated by a vortex flow of the fluid.

An example of a conventional cyclone air purifier is disclosed in Korean Patent No. 527358. The disclosed cyclone air purifier includes a case forming an outer appearance, a fan mounted to an inner upper portion of the case, multiple (e.g., twelve) cyclones mounted in parallel under the fan to separate dust from air, a dust-collecting tank provided under the cyclones, and a filter for removing fine particles from the air flowing out of the cyclones.

When the fan rotates, the indoor air flows into the cyclones. Dust in the inhaled air is separated from the air by the centrifugal force in the cyclones, and collected in the dust collecting tank. The air, from which dust is removed, flows out of the cyclones, and passes through the filter. While passing through the filter, fine particles, which may remain in the air, are removed from the air by the filter, and clean air is discharged to an indoor room.

However, in the above-described conventional cyclone air purifier, when reducing the number of revolutions of the fan to change an air flow rate, dust-collecting efficiency of the cyclone is decreased. Because cross-sectional areas of the cyclones through which the air passes are constant, speed of the air flow passing through the cyclones when the fan rotates with a relatively low speed (e.g., 1200 rpm) is lower than the speed of the air flow when the fan rotates with a relatively high speed (e.g., 2000 rpm). In other words, as the number of revolutions of the fan is reduced, the speed of the air flow passing through the cyclones is also reduced, and so the dust-collecting efficiency of the cyclones is also deteriorated because of the operational features of using centrifugal force.

In some cases (e.g., when flow resistance is increased by dust caught in the filter or by obstacles adhered to an air inlet or air outlet of the air purifier), the speed of the air flow passing through the cyclones is decreased below a reference value which is required for achieving a predetermined minimum dust-collecting efficiency. However, because the cyclone air purifier has no device for coping with the decrease in the speed of the air flow passing through the cyclones, the dust-collecting efficiency and the operational reliability cannot be adequately maintained or guaranteed.

### SUMMARY OF THE INVENTION

The present general inventive concept provides an air purifier and a control method thereof which can change an air flow rate without deteriorating a dust-collecting efficiency.

The present general inventive concept provides an air purifier and a control method thereof which can prevent a speed of an air flow passing through the cyclones from falling below a reference value, to stably achieve a predetermined dust-collecting performance.

Additional aspects and/or advantages of the present general inventive concept will be set forth in part in the description which follows and, in part, will be obvious from the description, or may be learned by practice of the general inventive concept.

The foregoing and/or other aspects of the present general inventive concept may be achieved by providing an air purifier including a main body, a fan mounted in the main body, two or more cyclones to create a vortex air flow when the fan rotates and to separate dust from air, and at least one open/close unit to open and close at least one of the cyclones.

The cyclones may be disposed in parallel with each other under the fan.

The open/close unit may include a valve member mounted to at least one of the cyclones, and a motor to drive the valve member.

Each of the cyclones may include an outflow pipe, through which the air passes after dust is removed from the air in the cyclone, and the valve member may be provided at the outflow pipe.

The cyclones may include an open type cyclone, which is kept in an open state regardless of the number of revolutions of the fan.

The fan may be a centrifugal fan, and the open type cyclone may be disposed at a position corresponding to a center portion of a suction side of the fan.

The air purifier may further include an anemometer mounted to at least one of the cyclones to measure the speed of air flow in the cyclone. The anemometer may be mounted to the open type cyclone.

The foregoing and/or other aspects of the present general inventive concept may also be achieved by providing an air purifier including a fan having a variable rotational speed according to a user-desired air flow rate, two or more cyclones to communicate with the fan, and a control unit to control the cyclones according to the variable rotational speed of the fan, and to perform a first mode in which air flow generated by the fan passes through all of the cyclones, and a second mode in which the air flow generated by the fan passes through a portion of the cyclones.

The air purifier may further include an anemometer mounted to at least one of the cyclones to measure a speed of air flow in the cyclone. If the speed of the air flow measured by the anemometer is less than a reference value, the control unit performs a third mode of closing at least one of the open cyclones.

The foregoing and/or other aspects of the present general inventive concept may also be achieved by providing a method of controlling an air purifier including a fan having a variable number of revolutions per unit time and/or a number of cyclones to communicate with the fan, the method including receiving a user-desired air flow rate, opening and closing the cyclones according to the user-desired air flow rate, and driving the fan by a predetermined number of revolutions according to the user-desired air flow rate.

The method may further include measuring a speed of air flow in one of the cyclones, comparing the measured speed of the air flow with a reference value, and if the measured speed of the air flow is less than the reference value, closing at least one of the open cyclones.

### BRIEF DESCRIPTION OF THE DRAWINGS

These and/or other aspects and advantages of the exemplary embodiments of the present general inventive concept will become apparent and more readily appreciated from the following description of the embodiments, taken in conjunction with the accompanying drawings, of which:

FIG. 1 is a perspective view illustrating an outer appearance of an air purifier according an embodiment of the present general inventive concept;

FIG. 2 is an exploded perspective view illustrating components of the air purifier of FIG. 1;

FIG. 3 is an exploded perspective view illustrating partition plates, a suction grill and cyclones in the air purifier of FIG. 2;

FIG. 4 is a perspective view illustrating a cyclone equipped with an anemometer in an air purifier according to an embodiment of the present general inventive concept;

FIG. 5 is a partial cross-sectional view illustrating an open/close type cyclone and an open/close unit in an air purifier according to an embodiment of the present general inventive concept;

FIG. 6 is a block diagram illustrating an air purifier according to an embodiment of the present general inventive concept; and

FIG. 7 is a flow chart illustrating a method of controlling an air purifier according to an embodiment of the present general inventive concept.

### DETAILED DESCRIPTION OF EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

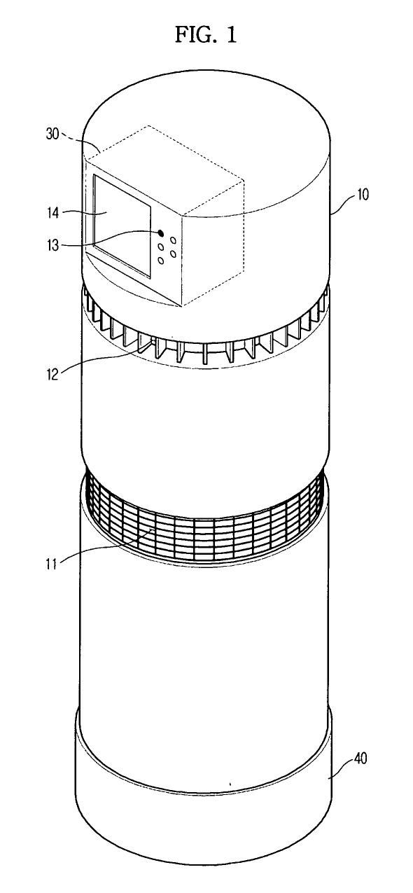

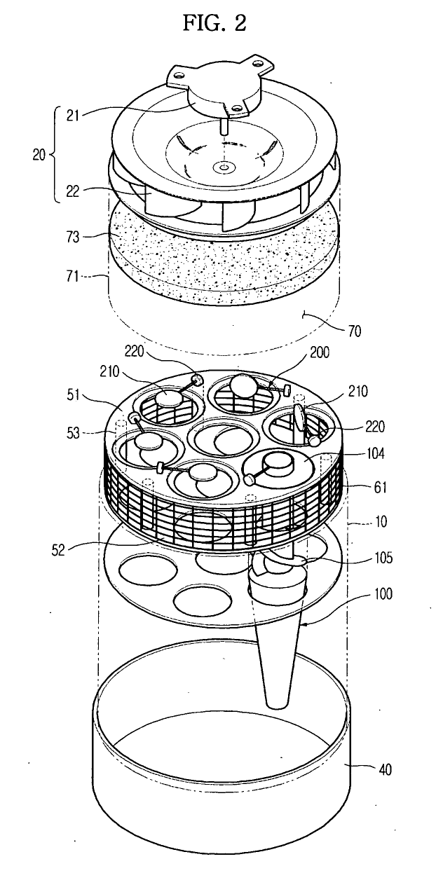

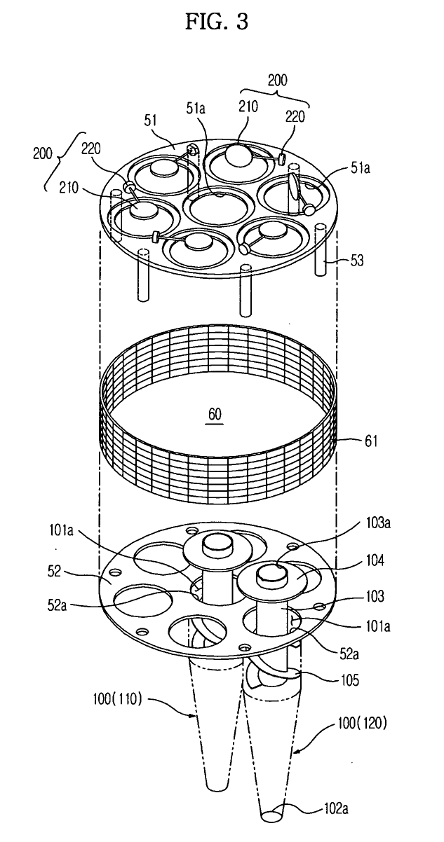

FIG. 1 is a perspective view illustrating an outer appearance of an air purifier according to an embodiment of the present general inventive concept. FIG. 2 is an exploded perspective view illustrating components of the air purifier of FIG. 1. FIG. 3 is an exploded perspective view illustrating partition plates, a suction grill and cyclones in the air purifier of FIG. 2.

As illustrated in FIGS. 1 and 2, the air purifier according to an embodiment of the present general inventive concept includes a main body 10 which forms an outer appearance, a blowing device 20 which is mounted to an inner upper portion of the main body 10 to forcibly circulate air, multiple cyclones 100 which are mounted parallel under the blowing device 20 to separate dust from the air by creating a vortex air flow while the blowing device 20 operates, and a control unit 30 which controls operation of the air purifier.

The main body 10 is formed with an air inlet 11 and an air outlet 12. The main body 10 may be provided with selecting buttons 13 to select an operating mode and a display 14 to display an operating state of the air purifier at an upper portion. The main body 10 may further be provided with a dust-collecting case 40 which may be detachably coupled to a lower portion of the main body 10. The dust-collecting case 40 may be used to collect and to store dust which is removed from the air while passing through the cyclones 100.

The blowing device 20 may include a fan motor 21 and a fan 22 which is connected to the fan motor 21. The fan motor 21 may adjust or change the rotational speed of the fan 22. A centrifugal fan may be used as the fan 22, which sucks the air in an axial direction (e.g., from inlet 11 through cyclones 100) and discharges the air in a radial direction (e.g., through outlet 12). A suction (e.g., inflow) side of the fan 22 may ultimately communicate with outflow pipes 103 (see an embodiment of the present general inventive concept illustrated in FIG. 3) of the cyclones 100.

As illustrated in FIGS. 2 and 3, two partition plates 51 and 52 are provided under the fan 22. The two partition plates 51 and 52 are separated from each other, and supporting members 53 are interposed therebetween. Hereinafter, the partition plate 51 located above the other partition plate 52 will be called a first plate, and the partition plate 52 located under the first plate 51 will be called a second plate.

A suction space 60 is defined between the first partition plate 51 and the second partition plate 52, in which the air sucked through the air inlet 11 may be concentrated (or pressurized). A suction grill 61 is mounted circumferentially at the suction space 60. A discharging space 70 is defined between the first partition plate 51 and the fan 22, in which the air flowing out of the cyclones 100 is concentrated. A discharging duct 71 is mounted at the discharging space 70 to guide the air flowing out of the cyclones 100 to the suction (or inflow) side of the fan 22.

The discharging space 70 communicates with outflow holes 103a of the cyclones 100, and the suction space 60 communicates with inflow holes 101a of the cyclones 100. For this, the first partition plate 51 and the second partition plate 52 are formed with first openings 51a and second openings 52a, respectively.

A filter 73 may be provided in the discharging duct 71. The filter 73 is used to remove fine particles, which may remain in the air flowing out of the cyclones 100 and into filter 73 via discharging space 70.

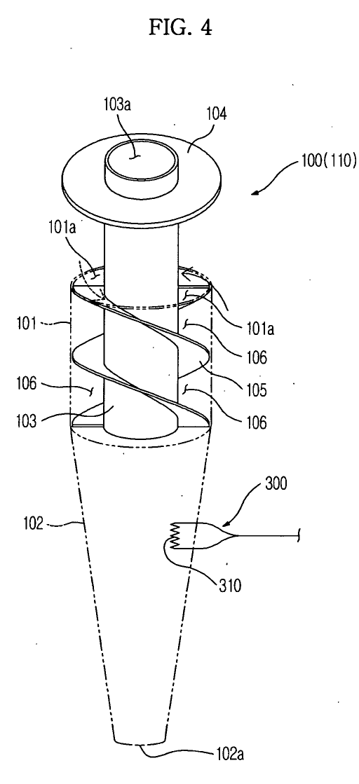

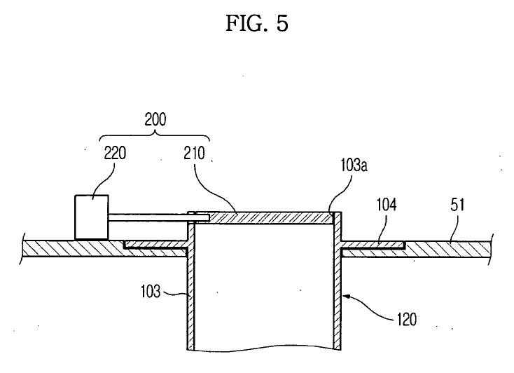

FIG. 4 is a perspective view illustrating a cyclone 100 equipped with an anemometer 300, and FIG. 5 is a partial cross-sectional view illustrating an open/close type cyclone and an open/close unit 200, according to embodiments of the present general inventive concept.

Referring to FIGS. 2 to 4, the multiple cyclones 100 may be arranged in parallel with each other under fan 21. The multiple cyclones may be flush mounted such that supporting plates 104 lie essentially in the same horizontal plane. Each cyclone 100 includes a cylindrical portion 101. The cylindrical portion 101 is formed with an inflow hole 101a at an upper end, through which the air flows into the cylindrical portion 101 from the suction space 60. Each cyclone 100 includes a cylindrical portion 101 in which the air entering into the cyclone 100 is directed into a downward to form a vortex air flow pattern, a conic portion 102 which extends downward from the cylindrical portion 101 and in which the centrifugal force of the downward vortex air flow is enhanced, and an outflow pipe 103 which guides and accepts the outflow of the air which upwardly rises at the center of the cyclone 100 (e.g., after being downwardly directed from inflow hole 101a toward the conic portion 102). The conic portion 102 is formed with an exhausting hole 102a at a lower end, through which dust separated from the air by the centrifugal force is exhausted toward the dust-collecting case 40. The outflow pipe 103 is formed with an outflow hole 103a at an upper end, through which the air flows toward the discharging space 70 after the dust-separation.

A circular supporting plate 104 is formed at the outer circumference of the outflow pipe 103 near the outflow hole 103a. As illustrated in FIG. 5, the supporting plate 104 is seated on the first partition plate 51 so that the cyclone 100 is supported by the first partition plate 51. The supporting plate 104 is seated a gap between the first opening 51a of the first partition plate 51 and the outflow pipe 103, to prevent the air from leaking from the suction space 60 into the discharging space 70.

A pair of spiral collars 105 may be formed around the outflow pipe 103 inside the cylindrical portion 101. A vortex flow path 106 is defined by the spiral collars 105, the outer surface of the outflow pipe 103 and the inner surface of the cylindrical portion 101, which guides the vortex flow of air entering into the cylindrical portion 101 via inflow hole 101a. FIGS. 3 and 4 illustrate two spiral collars 105 (e.g., two full revolutions of spirals 105). However, the number of the spiral collars may be increased or decreased.

The spiral collars 105 may be formed integrally with the outflow pipe 103, and inserted into the cylindrical portion 101 together with the outflow pipe 103. For example, the spiral collars 105 may be forcibly fitted into the cylindrical portion 101, or the cylindrical portion 101 may be formed with spiral grooves at an inner circumference corresponding to the spiral collars 105 so that the spiral collars 105 may be tightened along the spiral grooves in cylindrical-portion 101.

The multiple cyclones 100 may include open type cyclones 110 which are always kept in opened state regardless of the number of revolutions of the fan 22, and/or open/close type cyclones 120 which may be opened and closed by open/close units 200 according to the number of revolutions of the fan 22 (e.g., rpms of the fan 22).

When reducing the number of revolutions of the fan 22 to change the air flow rate, the proper numbers of the open/close type cyclones 120 are closed so that the air flow generated by the fan 22 passes through only the opened cyclones to prevent the dust-collecting efficiency from being deteriorated. In order words, when the number of revolutions of the fan 22 is relatively large (e.g., high rpms), more cyclones may be opened, and when the number of revolutions of the fan 22 is relatively small (e.g., low rpms), fewer cyclones may be opened. Accordingly, the speed of the air flow (e.g., pressure) passing through the cyclones can be maintained substantially constant by adjusting the total open cross-sectional area of the cyclones for to accept and to permit air flow therethrough according to the changed number of revolutions of the fan 22, and the predetermined dust-collecting efficiency can be stably maintained (e.g., even at low fan 22 rpms).

Although FIGS. 2 and 3 illustrate one open type cyclone and six open/close type cyclones in the air purifier, the numbers of the open type cyclones and the open/close type cyclones may be changed (e.g., increased or decreased) as needed.

As illustrated in FIGS. 3 and 5, each of the open/close units 200 includes a plate-shaped valve member 210 which is provided at the outflow hole 103a of the outflow pipe 103 of the open/close type cyclone 120 to open and close the outflow hole 103a, and a stepping motor 220 which is mounted to the first partition plate 51 to rotate the valve member 210 by a predetermined angle (e.g., 90 degrees between open and close positions). As illustrated in FIGS. 3 and 5, one stepping motor 220 per valve member 210 is provided to rotate the valve members 210 independently. However, the structure may be modified such that two or more valve members can be rotated by one stepping motor by using couplings or joints. Other configurations may be used.

As illustrated in FIGS. 2 and 3, the open type cyclone 110 may be positioned at the position corresponding to the central portion of the fan 22, and to dispose the open/close type cyclones 120 circumferentially around the open type cyclone 110. Such a structure is envisioned by considering the operating features that the centrifugal fan 22 sucks the air in the axial direction. If the open type cyclone 110 is located corresponding to the central portion of the fan 22 as described above, then when all open/close type cyclones 120 are closed, the air passes through only the centrally located open type cyclone 110, and the maximum sucking force of the fan 22 is applied more directly to the open type cyclone 110 more effectively. Such a configuration maximizes the dust-collecting efficiency of the open type cyclone 110, pursuant to an embodiment of the present general inventive concept.

As illustrated in FIG. 4, the open type cyclone 110 is provided with an anemometer 300 to measure the speed of the air flow passing through the open type cyclone 110. The anemometer 300 enables the cyclones to maintain the dust-collecting efficiency not less than a predetermined value. During the operation of the air purifier, when the speed of the air flow measured by the anemometer 300 falls below a reference value necessary to provide a predetermined dust-collecting efficiency, a sufficient number of the open/close type cyclones (which have been opened) are closed to decrease the number of the cyclones for the dust-collecting. By doing so, the predetermined minimum dust-collecting efficiency is satisfied.

Although FIG. 4 illustrates a hot-wire anemometer including a hot wire 310 is used, different anemometers (or equivalents thereof) may be used. The hot-wire anemometer measures the speed of the air flow by transforming the change of the temperature of the hot wire 310 (when the air flow contacts the hot wire 310) into a change of the electric resistance thereof.

Pursuant to an embodiment of the present general inventive concept, data regarding the operating conditions of the air purifier may be stored in control unit 30. The data may include the number of revolutions of the fan 22 (e.g., rpms) and the number of the open/close type cyclones 120 which should be closed according to the operating mode (the air flow rate) selected by the user. For example, as illustrated in FIGS. 2 and 3, when one open type cyclone and six open/close type cyclones are provided in the air purifier, the data (such as the data in following table 1) may be stored in the control unit 30.

TABLE 1

| | number of | | |
|---|---|---|---|
| operating | open/close type | discharged air | number of |
| mode | cyclones which | flow rate | revolutions of fan |
| (air flow rate) | should be closed | (CMM) | (RPM) |
| turbo | 0 | 5.0 | 2000 |
| strong | 2 | 3.5 | 1800 |
| medium | 4 | 2.1 | 1500 |
| weak | 6 | 0.7 | 1200 |

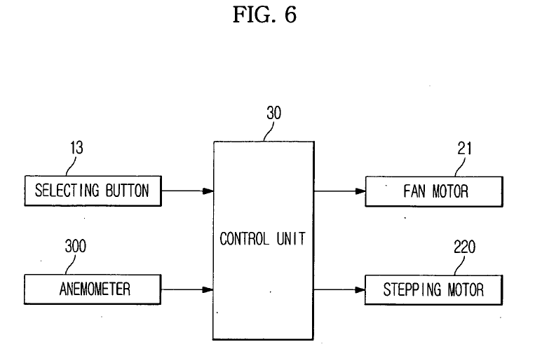

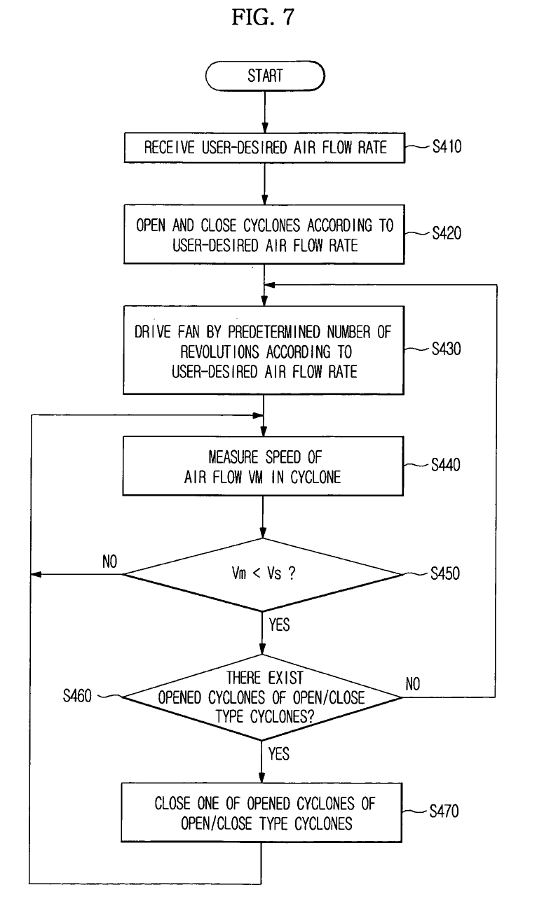

Hereinafter, an operation and a control method of the air purifier according to an embodiment of the present general inventive concept is described with reference to FIGS. 2, 3, 6 and 7 and the table 1. According to an embodiment of the present general inventive concept, FIG. 6 is a block diagram illustrating components of the air purifier. FIG. 7 is a flow chart showing a method of controlling the air purifier according to an embodiment of the present general inventive concept.

Referring to FIGS. 2, 3, 6 and 7, the control unit 30 is set to a particular operating mode (a user-desired air flow rate), which the user selects by manipulating the selecting buttons 13, at operation S410. Based on the selected user-desired air flow rate, the control unit 30 controls the stepping motors 220 of the open/close units 200 to close some of the open/close type cyclones 120 at operation S420. The control unit 30 also controls the fan motor 21 of the blowing device 20 to rotate the fan 22 by the predetermined number of the revolution at operation S430. For example, if the data of table 1 is pre-stored in the control unit 30, then when the user selects the operating mode of “strong”, the control unit 30 closes two open/close type cyclones 120 and opens four open/close type cyclones 120 (or maintains enough open/close type cyclones to have a net result of 4 out of 6 in an open state). Also, the control unit 30 rotates (or may rotate) the fan 22 at 1800 rpm, according to an embodiment of the present general inventive concept.

If the fan 22 rotates by the predetermined number of revolutions (e.g., 1800 rpm), the indoor air is sucked into the suction space 60, and then flows into the cylindrical portions 101 of the cyclones through the inflow holes 101a of the opened cyclones. For example, during the operating mode of “strong”, the air flows into one open type cyclone and four open/close type cyclones which are in the position. The air entering into the cylindrical portions 101 of the open cyclones forms the vortex air flow while moving along the vortex flow path 106 defined by the spiral collars 105. The air flows into the conic portion 102 from the cylindrical portion 101. The conical shape (e.g., as illustrated in FIGS. 2, 3 and 4 or equivalent thereof where the diameter of the cone is gradually reduced) increases the rotating speed of the vortex air flow. Accordingly, dust in the air is (e.g., more readily) separated from the air by the centrifugal force created by the vortex air flow, and directed to be collected in the dust-collecting case 40 through the exhausting hole 102a formed at the lower end of the conic portion 102. The air, from which dust is separated, reversely rises (e.g., upwardly) at the center of the cyclone 100, and is discharged to the discharging space 70 through the outflow pipe 103 and the outflow hole 103a. The suction upward of air towards discharging space 70 is facilitated by rotation of fan 22. The air in the discharging space 70 is filtered by the filter 73 while passing through the discharging duct 71, and finally discharged into the indoor room through the gaps in fan 22 and the air outlet 12.

In such a dust-collecting process, the anemometer 300 which may be mounted in the open type cyclone 110 may be used to measure the speed of the air flow inside the cyclone 110. The anemometer then transmits the measured speed value to the control unit 30 at operation S440. The control unit 30 compares the measured speed value Vm with a reference value Vs at operation S450. If the measured speed value Vm is less than the reference value Vs (Vm<Vs), then the control unit 30 determines whether there exist opened cyclones of the open/close type cyclones or not at operation S460. Here, the reference value Vs is the speed of the air flow in the cyclone which is required to achieve the predetermined minimum dust-collecting performance (e.g., strong, etc.; see Table 1 for example).

If the control unit 30 determines that there exist opened cyclones of the open/close type cyclones, the control unit 30 controls the stepping motor 220 to close one (e.g., or more) of the opened cyclones of the open/close type cyclones at operation S470. After closing one of the opened cyclones of the open/close type cyclones, if the measured speed value Vm is still less than the reference value Vs (Vm<Vs), the control unit 30 closes the opened cyclones of the open/close type cyclones one by one until the measured speed value Vm is equal to or more than the reference value Vs. Although the method illustrates one by one closing, the control unit may be set to close opened cyclones in pairs or other predetermined or programmed manner.

On the other hand, when the measured speed value Vm is less than the reference value Vs (Vm<Vs), if the control unit 30 determines that there exist no opened cyclones of the open/close type, the control unit 30 controls the air purifier to perform the dust-collecting operation as is.

As apparent from the above description, the air purifier according to the present general inventive concept can change (e.g., automatically adjust) the operating numbers of the dust-collecting cyclones according to the selected air flow rate to stably maintain the dust-collecting efficiency even when the air flow rate is reduced.

Also, since the air purifier can measure the speed of the air flow in the cyclone and change the operating number of the dust-collecting cyclones correspondingly, the air purifier can stabilize the predetermined dust-collecting performance even when the speed of the air flow in the cyclone is reduced.

Although embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. An air purifier comprising:
a main body;
a fan mounted in the main body;
cyclones to create a vortex air flow when the fan rotates and to separate dust from air; and
at least one open/close unit to open and close at least one of the cyclones.

2. The air purifier according to claim 1, wherein the cyclones are disposed in parallel with each other under the fan.

3. The air purifier according to claim 1, wherein the open/close unit comprises a valve member mounted to at least one of the cyclones, and a motor to drive the valve member.

4. The air purifier according to claim 3, wherein:
each of the cyclones comprises an outflow pipe, through which the air passes after dust is removed from the air in the cyclone; and
the valve member is provided at the outflow pipe.

5. The air purifier according to claim 1, wherein the cyclones comprise an open type cyclone.

6. The air purifier according to claim 5, wherein:
the fan is a centrifugal fan; and
the open type cyclone is disposed at a position corresponding to a center portion of a suction side of the fan.

7. The air purifier according to claim 1, further comprising:
an anemometer mounted to at least one of the cyclones to measure a speed of air flow in the cyclone.

8. The air purifier according to claim 7, wherein:
the cyclones comprise an open type cyclone; and
the anemometer is mounted to the open type cyclone.

9. An air purifier comprising:
a fan having a variable number of revolutions according to a user-desired air flow rate;
cyclones to communicate with the fan; and
a control unit to control an open/close state of the cyclones according to the number of revolutions of the fan, the control unit to perform a first mode in which air flow generated by the fan passes through all of the cyclones, and a second mode in which the air flow generated by the fan passes through a portion of the cyclones.

10. The air purifier according to claim 9, further comprising:
an anemometer mounted to at least one of the cyclones to measure a speed of air flow in the cyclone,
wherein if the speed of the air flow measured by the anemometer is less than a reference value, the control unit performs a third mode to close at least one of the cyclones which are in an open state.

11. A method of controlling an air purifier including a fan having a number of revolutions per unit time and having cyclones to communicate with the fan, the method comprising:
receiving a user-desired air flow rate;
opening and closing the cyclones according to the user-desired air flow rate; and
driving the fan by a predetermined number of revolutions per unit time according to the user-desired air flow rate.

12. The method according to claim 11, further comprising:
measuring a speed of air flow in one of the cyclones;
comparing the measured speed of the air flow with a reference value; and
if the measured speed of the air flow is less than the reference value, closing at least one of the cyclones which are in an open state.

13. An air purifier comprising:
a plurality of cyclones to create an air flow to remove a foreign material from the air flow; and
an open/close unit to selectively prevent the air flow of at least one of the plurality of cyclones according to a characteristic of the air flow.

14. The air purifier of claim 13, further comprising:
a fan to forcibly control the air flow of the plurality of cyclones, wherein a rotational speed of the fan is variable according to the characteristic of the air flow.

15. The air purifier of claim 13, further comprising:
a measuring unit mounted in one of the cyclones to measure the characteristic of the air flow.

16. The air purifier of claim 15, wherein the measuring unit comprises a hot-wire anemometer.

17. The air purifier of claim 13, wherein the characteristic of the air flow comprises a speed of the air flow.

18. The air purifier of claim 13, wherein the open/close unit comprises a plurality of valve members to correspond to the cyclones, and a driving unit to drive the valve members to selectively prevent the air flow.

19. The air purifier of claim 18, wherein the valve members are disposed at outlets of the cyclones.

20. The air purifier of claim 13, wherein each of the cyclones comprises an inlet, an exhausting hole, an outlet, and the open/close unit is disposed on the outlet.

21. The air purifier of claim 13, further comprising:
a control unit to control the open/close unit in a plurality of modes in which a first number of cyclones and a second number of cyclones is determined to prevent the air flow thereof.
